(19) United States
(12) Patent Application Publication
(10) Pub. No.: US 2002/0184053 A1
(43) Pub. Date: Dec. 5, 2002

(54) Method for dynamically including diagnostic findings in report summary

(76) Inventor: Robert Stanley Arling, North Andover, MA (US)

Correspondence Address: PHILIPS ELECTRONICS NORTH AMERICAN, 580 WHITE PLAINS ROAD, TARRYTOWN, NY, 10591, US

(21) Appl. No.: 09/874,507

(22) Filed: Jun. 5, 2001

(51) Int. Cl. G06F 17/60

(52) U.S. Cl. 705/2

(57) ABSTRACT

A software program assisting the generation of a medical report. The software program (a) displaying pre-chosen findings and a separate medical report simultaneously on an electronic display, the medical report comprising a summary section; and (b) automatically copying electronically a respective pre-chosen finding selected from the pre-chosen findings into the summary section of the medical report.

### BACKGROUND OF THE INVENTION

1. Description of the Related Art

When a patient undergoes a diagnostic procedure such as an echocardiogram, the results of the exam are contained in a report written by the physician reading the exam. One of the steps involved in creating this report is the selection of diagnostic “findings” which describe the underlying diagnosis and/or other relevant information pertaining to the exam. These findings are descriptive text phrases which describe a wide range of pathology one would expect to encounter in a clinical setting and which can be customized by the user to fit their particular reporting scheme. A collection of relevant findings is chosen by the report author. These findings then appear in the report. In another section of the report is a summary of the important results for that study.

The report can be broken into different sections. For example, groups of an echocardiogram report can include different parts of the heart, such as left ventricle, right ventricle, tricuspid valve, aortic valve, pulmonic valve, great vessels, pericardium/pleural, etc. Each of these groups may have a separate corresponding section in the report. Relevant findings are then associated with each section.

Typically, a report may contain a summary section on top and then group sections which contain findings for each group. The summary section repeats selected findings in the group sections which are the most important. In this way, a reader of the report can instantly identify which findings are the most important by merely reading the summary section. For more details, the reader can then read the group sections which contain all of the findings.

A physician writing the report typically desires to include certain findings in the group sections in the summary section. Previously, there was no easy way for the physician to do this.

One prior art method of selectively including certain findings into the summary section is the pre-programming of certain findings to appear in the summary section. For example, findings predetermined to be important would be automatically copied into the summary section.

However, a problem with this method is that the physician may decide that additional findings should also be present in the summary section, besides those that are preprogrammed. Alternatively, the physician may decide that in a particular case, findings preprogrammed to appear in the summary section should not appear there.

One way a physician can overcome the above shortcomings is by manually typing in a finding by hand into the summary section. However, this method is burdensome to the physician, and can result in typographical errors. Further, if the physician is initially unsure of which findings to include in the summary section, he may spend a great deal of time manually editing the summary section.

Therefore, what is needed is a method of generating a medical report wherein the physician can automatically generate a summary section based on the physician's chosen findings in a dynamic and burden free manner.

### SUMMARY OF THE INVENTION

The present invention is directed to a software program allowing a physician to generate a medical report in a dynamic and easy manner. The software program operates by (a) displaying pre-chosen findings and a separate medical report simultaneously on an electronic display, the medical report comprising a summary section; and (b) automatically copying electronically a respective pre-chosen finding selected from the pre-chosen findings into the summary section of the medical report.

Further, the invention also includes an apparatus and also a computer readable storage medium instructing a computer to perform the above methods.

### BRIEF DESCRIPTION OF THE DRAWINGS

The details of the invention will become apparent and more readily appreciated from the following description of the preferred embodiments, taken in conjunction with the accompanying drawings, of which:

FIG. 1 is a screen shot illustrating the operation of a software program, and more particularly the report area and the work area, according to an embodiment of the present invention.

FIG. 2 is a screen shot illustrating the operation of a software program, and more particularly illustrates the selection of findings, according to an embodiment of the present invention.

FIG. 3 is a screen shot illustrating the operation of a software program, and more particularly the generation of the group sections, according to an embodiment of the present invention.

FIG. 4 is a screen shot illustrating the operation of a software program, and more particularly the listing of findings from various group sections, according to an embodiment of the present invention.

FIG. 5 is a screen shot illustrating the operation of a software program, and more particularly the automatic copying of findings into the summary, according to an embodiment of the present invention.

FIG. 6 is a flowchart illustrating typical operations performed in order to generate a medical report, according to an embodiment of the present invention.

### DETAILED DESCRIPTION OF THE INVENTION

Reference will now be made in detail to the present preferred embodiments of the present invention, examples of which are illustrated in the accompanying drawings, wherein like reference numerals refer to like elements throughout.

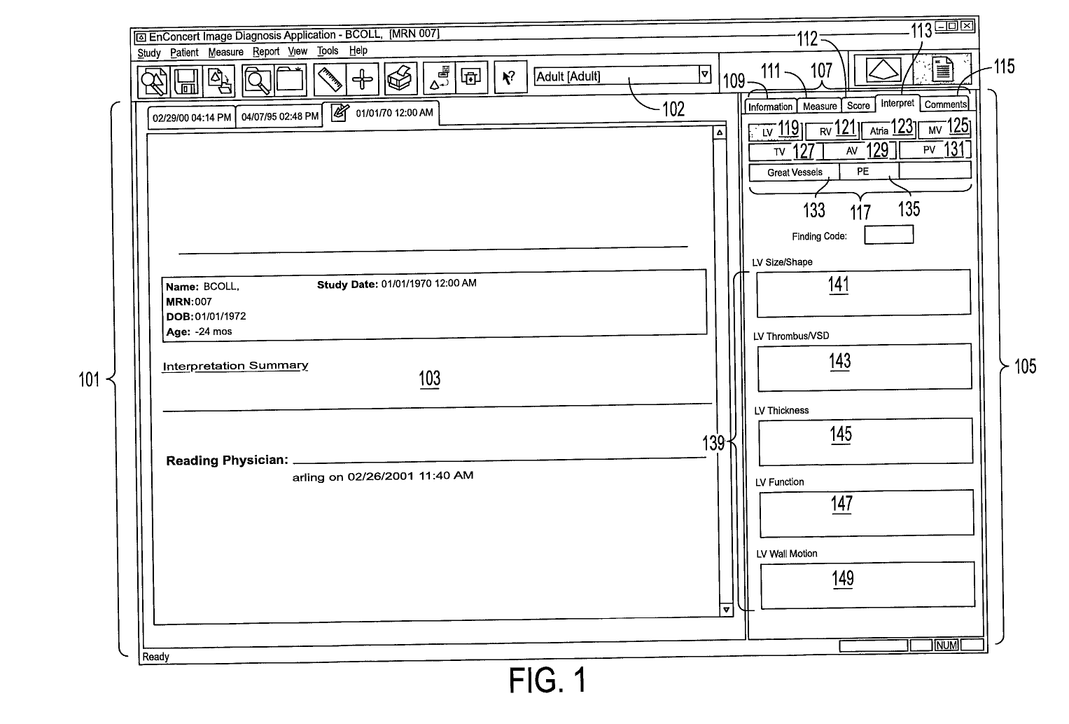

FIG. 1 is a screen shot illustrating the operation of a software program, and more particularly the report area and the work area, according to an embodiment of the present invention. Referring now to FIG. 1, the display typically comprises a report area 101 and a work area 105. The report area displays a medical report 103.

A report selection box 102 allows a physician to select a particular type of report to work on. In this particular example, an “Adult” report is selected. However, numerous other types of reports can be generated, for example “pediatric” or “stress,” etc. The selection of the report type may change other aspects and options of the display. For example, changing the type of report in the report selection box 102 may change any of the displayed selections discussed below to vary to be applicable to the report selected.

The work area 105 may typically display report page tabs 107. In this particular example, the report tabs are the Information tab 109, Measure tab 111, Score tab 112, Interpret tab 113, and Comments tab 115. The report page tabs 107 allow the physician to select a particular part of report he/she wishes to work on. For example, the Information Tab 109 can allow the physician to enter in patient information, such as the patient's name, age, etc. These are only examples of tabs, and the present invention is not limited to these examples.

The work area 105 may also typically also display section buttons 117. In this particular example, the display section buttons 117 are displayed when the interpret tab 113 is selected. The section buttons 117 are LV section button 119, RV section button 121, Atria section button 123, MV section button 125, TV section button 127, AV section button 129, PV section button 131, Great Vessels section button 133 and PE section button 135. The section buttons 117 allow the physician to select a particular section that he/she wishes to work on. In this example, each section represents a different anatomical region of the heart, i.e. LV stands for “left ventricle,” RV stands for “right ventricle” etc. The section buttons 117 displayed are based on the selection of the report selection box 102. In this particular example, the section buttons 117 correspond to sections associated with an Adult report, since the Adult report type is currently selected in the report selection box 102. These are only examples of sections, and the present invention is not limited to these examples. Furthermore, the sections displayed for a particular report type might be configurable by the user, allowing more flexibility in generating medical reports of that particular type. This configurability may be implemented in another portion of the medical report generator program or in another auxiliary program used specifically for configuration.

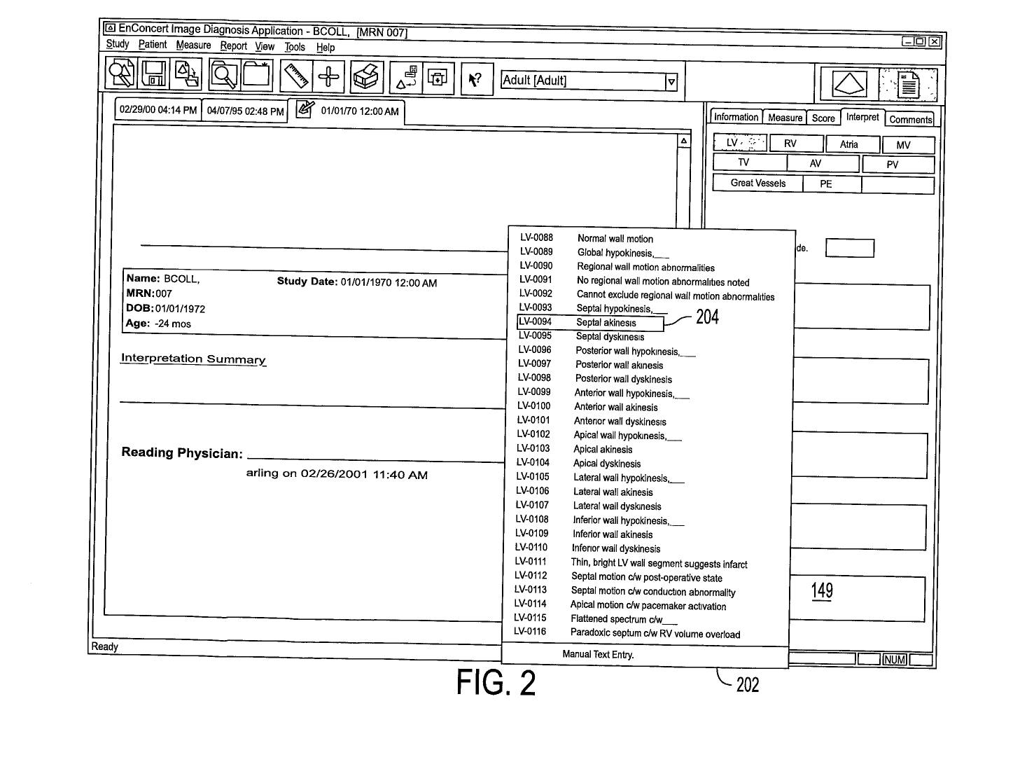

The work area 105 may also typically display finding group boxes 139. In this particular example, the finding group boxes 139 are LV Size/Shape finding group box 141, LV Thrombus/VSD finding group box 143, LV Thickness finding group box 145, LV Function finding group box 147, and LV Wall Motion finding group box 149. The finding group boxes 139 which are displayed correspond to which one of the section buttons 117 is pressed. These are only examples of finding group boxes, and the present invention is not limited to these examples. Furthermore, the finding group boxes displayed for a particular section might be configurable by the user, allowing more flexibility in generating medical reports. This configurability may be implemented in another portion of the medical report generator program or in another auxiliary program used specifically for configuration. FIG. 2 is a screen shot illustrating the operation of a software program, and more particularly illustrates the choosing of findings, according to an embodiment of the present invention. If the user selects one of the finding group boxes 139, a list of findings that are available for the selected group will be displayed. One possible way a user can select one of the finding group boxes 139 is by pointing a mouse to the desired finding group box and left or right clicking. However, other methods of selection can be used as well, for example at trackball or voice recognition.

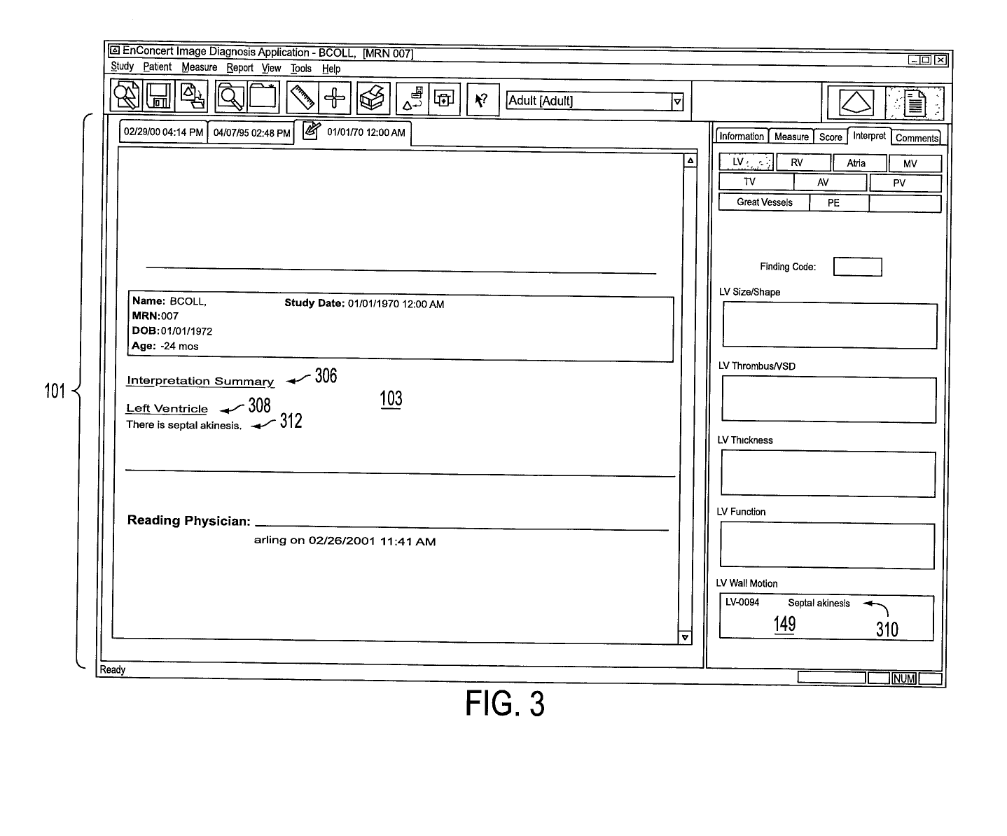

If the physician were to select the LV Wall Motion finding group box 149, a list of available findings for the LV Wall Motion finding group will be displayed. Referring now to FIG. 2, an available finding list 202 is displayed upon selection of the LV Wall Motion finding group box 149 of FIG. 1. The physician may then choose any desired finding(s) which are applicable to the report being generated. The choosing can typically be accomplished by using a mouse or keyboard. In this particular example, septal akinesis 204 is chosen by the physician. The chosen finding may appear highlighted. These are only examples of findings, and the present invention is not limited to these examples. Furthermore, the finding displayed for a particular group might be configurable by the user, allowing more flexibility in generating medical reports. This configurability may be implemented in another portion of the medical report generator program or in another auxiliary program used specifically for configuration.FIG. 3 is a screen shot illustrating the operation of a software program, and more particularly the generation of the group sections, according to an embodiment of the present invention.

Referring now to FIG. 3, the report area 101 displays the medical report 103. The medical report displayed in this particular example comprises an interpretation summary 306 and a Left Ventricle group section 308. Because septal akinesis was selected previously as a selected finding by the physician, the LV Wall Motion finding group box 149 contains a septal akinesis finding 310 inside the LV Wall Motion finding group box 149. In addition, the Left Ventricle group section 308 also displays a septal akinesis finding 312. Note that the septal akinesis finding 310 which appears in the LV Wall Motion finding group box 149 is worded slightly differently from the septal akinesis finding 312 displayed in the Left Ventricle group section 308. Typically, the wording of findings used in finding group boxes may be abridged or abbreviated to fit inside the box. The findings used in the group sections in the report are typically more verbose and descriptive.

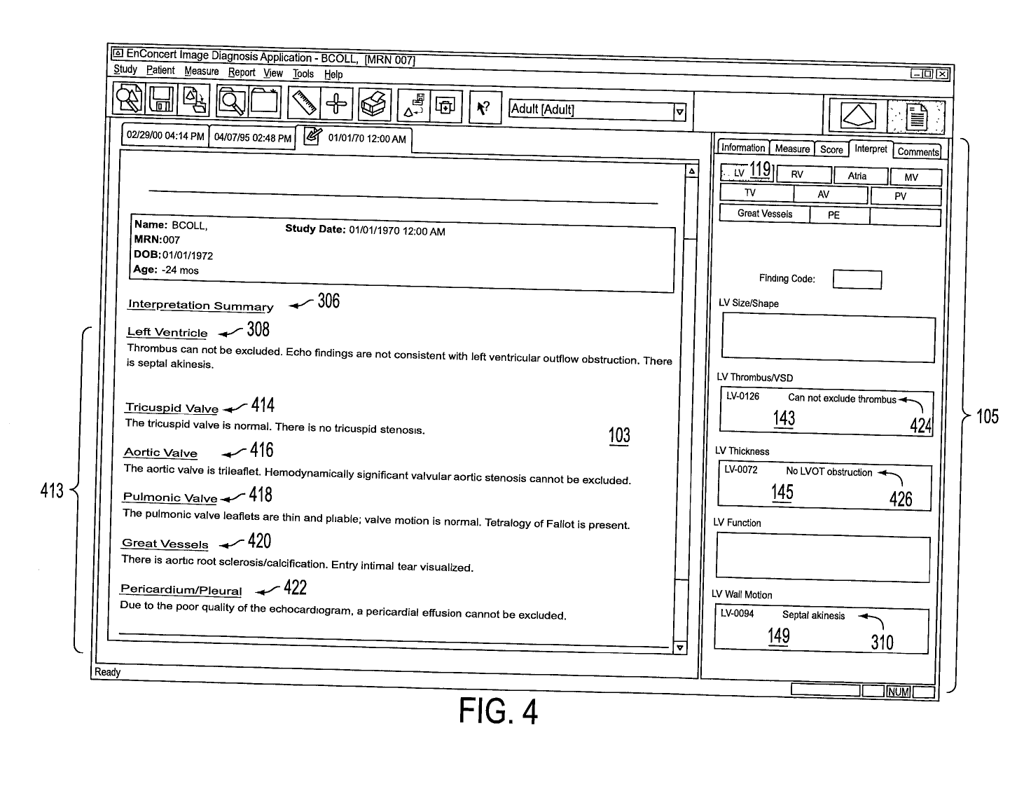

FIG. 4 is a screen shot illustrating the operation of a software program, and more particularly the listing of findings from various group sections, according to an embodiment of the present invention. Assuming that the physician selects numerous finding codes using the above described methods, a medical report can be generated that includes numerous findings in the various group sections.

Referring now to FIG. 4, the medical report 103 contains an interpretation summary 306 and numerous group sections 413. The group sections 413 are Left Ventricle group section 308, Tricuspid Valve group section 414, Aortic Valve group section 416, Pulmonic Valve group section 418, Great Vessels 420, and Pericardium/Pleural group section 422. The medical report 103 is one typical example of a report which can be generated by the methods of the present invention.

Note that all of the findings displayed in the work area 105 relate to the Left Ventricle group section 308 since the LV section button 119 is pressed. Note that the can not exclude thrombus finding 424 in the LV Thrombus/VSD group box 143, the no LVOT obstruction finding 426 in the LV Thickness group box 145, and the Septal akinesis finding 310 in the LV Wall Motion group box 149, are all displayed in the Left Ventricle group section 308 of the medical report 103.

While not pictured, if the physician were to press any of the other section buttons 117, the corresponding finding group boxes will be displayed for that group. For example, if the physician presses the TV section button 127, the corresponding finding group boxes will be displayed to list the chosen findings for the Tricuspid Valve group section 414.

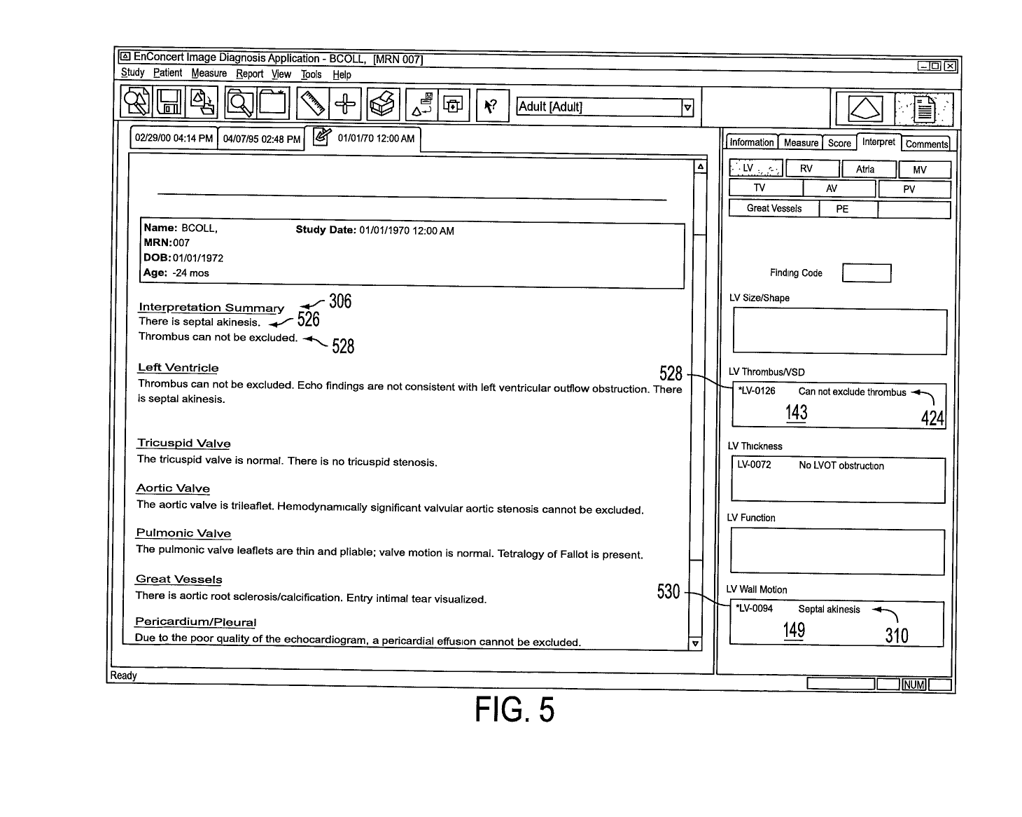

FIG. 5 is a screen shot illustrating the operation of the software program, and more particularly the automatic copying of findings into the interpretation summary 306. In the FIGS. 1-4, the interpretation summary 306 has been empty. The interpretation summary 306 is the section where the physician typically places the most important findings. When the physician desires to include a particular finding in the interpretation summary 306, he merely selects the desired findings and they will be automatically included in the interpretation summary 306. The selection can be made by a variety of methods, for example using a mouse to point to the desired finding and clicking the mouse. Note, however, that the selecting method used for copying a finding into the interpretation summary 306 should typically be different from the previous selection method used to initially choose a finding.

Referring now to FIG. 5, assume the physician has selected both the can not exclude thrombus finding 424 in LV Thrombus/VSD group box 143 and Septal akinesis finding 310 in the LV Wall Motion group box 149 to be included in the interpretation summary 306. The software program automatically copies the selected findings into the interpretation summary 306. The interpretation summary 306 includes a “There is septal akinesis” finding 526 and a “Thrombus can not be excluded” finding 528. The automatic copying is performed electronically, without any manual typing of the finding codes by the physician. One way the automatic copying is implemented can be by electronically transferring data representing the selected finding into a memory area of the computer where the interpretation summary is stored. In addition, the report can be stored using a data structure which entails easy inclusion/deletion of the selected findings. For example, the interpretation summary can be stored merely by a storing list of pointers or identifiers which point to the findings which are selected. Then the interpretation summary can be generated by displaying each of the selected findings in the list.

Further, when a finding is selected in a group box to be included in the interpretation summary, an indicator is used identifying the finding as such. An asterisk 528 is displayed next to the can not exclude thrombus finding 424, identifying that this finding is also displayed in the interpretation summary. An asterisk 530 is also displayed next to the septal akinesis finding 310 in the LV Wall Motion group box 149, identifying that this finding is also displayed in the interpretation summary. While an asterisk is used in the present example to identify inclusion in the interpretation summary, it can be appreciated that any type of identifier can be used, such as highlighting the finding, underlining the finding, etc.

If the physician changes his mind and decides that he no longer wants to include a particular finding in the interpretation summary, he can merely select that finding in the group box again. The finding will automatically be removed from the interpretation summary, and the indicator next to that finding in the group box will be removed.

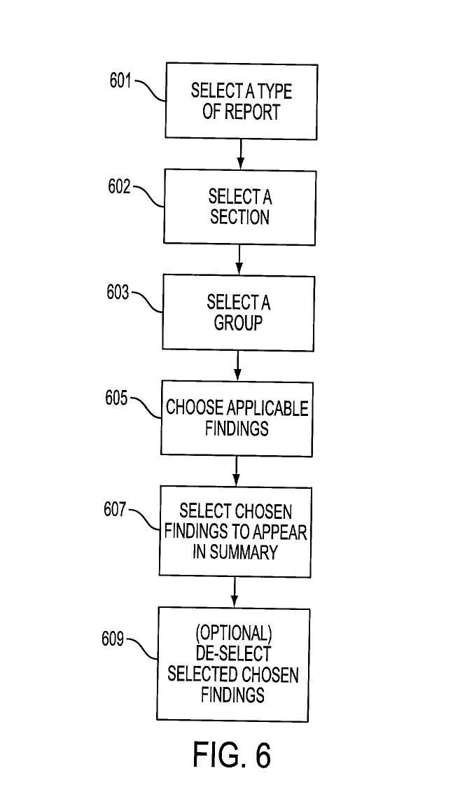

FIG. 6 is a flowchart illustrating typical operations performed in order to generate a medical report, according to an embodiment of the present invention. It can be appreciated by one of ordinary skill in the art that the illustrated operations need not be performed exactly as described, but are provided as merely one example of one possible implementation of the present invention.

Referring now to FIG. 6, a first operation performed in generating a medical report can be to select a type of report, illustrated as operation 601. The report selection box 102 illustrated in FIG. 1 illustrates one approach of how a type of report can be selected. Further, some embodiments of the invention may not even require a selection of a type of report, as one type of report may be all that is necessary.

After operation 601 is completed, the process continues to operation 602, wherein the physician can select a section of the report to work on using the section buttons 117. The section buttons 117 illustrated in FIG. 1 illustrate one approach of how a section can be selected. Further, some embodiments of the present invention may utilize only one section, in such cases operation 602 would not be necessary.

After operation 602 is completed, the process continues to operation 603 wherein the physician can select a group. The finding group boxes 139 illustrated in FIG. 1 illustrate one approach of how a group can be selected. A desired finding group boxes 139 is selected for which the physician desires to enter a finding.

After operation 603 is completed, the process continues to operation 605, wherein the physician can choose applicable findings for each group. The available finding list illustrated in FIG. 2 illustrates one approach of how findings can be chosen. The available findings displayed correspond to the particular finding group box which was selected.

Note that from operation 605, the process may return to operation 602 or operation 603, as the physician is free to choose applicable findings for particular sections or groups in any order he/she chooses.

From operation 605, the process continues to operation 607, wherein the physician can select some of the chosen findings which were chosen in operation 605 to appear in the summary section of the report.

From operation 607, the process may continue to optional operation 609, wherein the physician can deselect selected chosen findings. This would be the case if the physician changes his mind, and decides a chosen finding selected in operation 605 should no longer appear in the summary section. The physician merely again selects the previously selected chosen finding, and that finding will automatically be removed from the summary section.

Moreover, operations 602 to 609 can continuously be performed in any order, as the physician is free to refine the generated report to his liking.

As a result of the above described operation, the physician will have completed a medical report with ease. The medical report can typically be printed on a printing device after it is generated. Further, the medical reports generated by the above methods can be typically stored on a computer readable storage medium, such as a floppy disk, hard disk drive, optical storage, etc. In addition, the medical reports generated by the above methods can be made available to interested readers at remote locations through use of the internet, electronic facsimile, or other means.

Note that the above described methods are typically performed on a digital computer. The digital computer is not limited to being any particular type of computer, and might be, for example, a mainframe computer, a minicomputer, a desktop computer, a laptop computer, a personal digital assistant (PDA), or any other type of portable computing device or other computing device capable of executing a software program implementing the above described methods. In a typical scenario, the computer might be a laptop computer running a standard MICROSOFT WINDOWS based operating system. Of course, the present invention is not limited to any particular operating system running on computer. Further, any choosing or selecting as described above can typically be performed using a standard mouse or keyboard. However, other input devices may also be used to perform the above described operations, such as a trackball, voice input, etc. Additionally, the medical report can be displayed on any type of output device or display unit, for example a CRT monitor, LCD display, etc.

Moreover, the software program used to implement the above described methods on a digital computer can also be stored on any type of computer readable storage medium, including those described above.

Although a few preferred embodiments of the present invention have been shown and described it would be appreciated by those skilled in the art that changes may be made in these embodiments without departing from the principles and spirit of the invention, the scope of which is defined in the claims and their equivalents.

What is claimed is:

1. A method of generating a medical report, comprising:
displaying pre-chosen findings and a separate medical report simultaneously on an electronic display, the medical report comprising a summary section; and
automatically copying electronically a respective pre-chosen finding selected from the pre-chosen findings into the summary section of the medical report.

2. A method as recited in claim 1,
wherein the medical report further comprises a plurality of group sections, and
automatically copying electronically each pre-chosen finding into a group section of the plurality of group sections which corresponds to the pre-chosen finding.

3. A method as recited in claim 1, further comprising:
receiving a twice selected pre-chosen finding, the twice selected pre-chosen finding being previously selected and copied into the summary section of the medical report; and
automatically removing electronically the twice selected pre-chosen finding from the summary section of the medical report.

4. A method as recited in claim 1, further comprising selecting the pre-chosen findings from a list of available findings.

5. A method as recited in claim 1, further comprising displaying on the electronic display an indicator next to the selected pre-chosen finding, separate from the medical report

6. A method as recited in claim 5, further comprising:
receiving a twice selected pre-chosen finding, the twice selected pre-chosen finding being previously selected and copied into the medical report;
automatically removing electronically the twice selected pre-chosen finding in the summary section of the medical report; and
automatically removing electronically the indicator next to the twice selected pre-chosen finding.

7. A method as recited in claim 1, wherein the copying further comprises converting the selected pre-chosen finding into a more descriptive form before copying into the summary section.

8. A method comprising:
displaying a list of predetermined findings and a medical report simultaneously on an electronic display; and
when a respective predetermined finding is electronically selected from the list, automatically electronically copying said respective predetermined finding into the medical report.

9. A computer readable storage medium storing a computer program instructing a computer to perform a method of generating a medical report, the method comprising:
displaying pre-chosen findings and a separate medical report simultaneously on an electronic display, the medical report comprising a summary section; and
automatically copying electronically a respective pre-chosen finding selected from the pre-chosen findings into the summary section of the medical report.

10. A computer readable storage medium as recited in claim 9,
wherein the medical report further comprises a plurality of group sections, and
automatically copying electronically each pre-chosen finding into a group section of the plurality of group sections which corresponds to the pre-chosen finding.

11. A computer readable storage medium as recited in claim 9, further comprising:
receiving a twice selected pre-chosen finding, the twice selected pre-chosen finding being previously selected and copied into the summary section of the medical report; and
automatically removing electronically the twice selected pre-chosen finding from the summary section of the medical report.

12. A computer readable storage medium as recited in claim 9, further comprising selecting the pre-chosen findings from a list of available findings.

13. A computer readable storage medium as recited in claim 9, further comprising displaying on the electronic display an indicator next to the selected pre-chosen finding, separate from the medical report

14. A computer readable storage medium as recited in claim 13, further comprising:
receiving a twice selected pre-chosen finding, the twice selected pre-chosen finding being previously selected and copied into the medical report;
automatically removing electronically the twice selected pre-chosen finding in the summary section of the medical report; and
automatically removing electronically the indicator next to the twice selected pre-chosen finding.

15. A computer readable storage medium as recited in claim 9, wherein the copying further comprises converting the selected pre-chosen finding into a more descriptive form before copying into the summary section.

16. A computer readable storage medium storing a computer program instructing a computer to perform a method of generating a medical report, the method comprising:
displaying a list of predetermined findings and a medical report simultaneously on an electronic display; and
when a respective predetermined finding is electronically selected form the list, automatically electronically copying said respective predetermined finding into the medical report.

17. An apparatus comprising:
means for displaying a list of predetermined findings and a medical report simultaneously on an electronic display; and
when a respective predetermined finding is electronically selected form the list, means for automatically electronically copying said respective predetermined finding into the medical report.

18. An apparatus comprising:
a display unit displaying pre-chosen findings and a separate medical report simultaneously on an electronic display, the medical report comprising a summary section; and
a processing unit automatically copying a respective pre-chosen finding selected from the pre-chosen findings into the summary section of the medical report.
